(19) United States
(12) Patent Application Publication
(10) Pub. No.: US 2002/0192352 A1
(43) Pub. Date: Dec. 19, 2002

(54) Fat encapsulation compositions and method of preparing the same

(75) Inventor: Jamshed B. Dar, Reisterstown, MD (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MCCORMICK & COMPANY, INC., Sparks, MD

(21) Appl. No.: 10/128,466

(22) Filed: Apr. 24, 2002

Related U.S. Application Data
(60) Provisional application No. 60/285,685, filed on Apr. 24, 2001.

(51) Int. Cl. A23D 7/00

(52) U.S. Cl. 426/601

(57) ABSTRACT

Fat encapsulation compositions in which a dry ingredient is coated by a compressed layer of a high melting point fat may be prepared by subjecting a sandwich of a layer of the dry ingredient between two layers of the high melting point fat to pressure.

### BACKGROUND OF THE INVENTION

1. Field of the Invention

The present invention relates to fat encapsulation compositions. In particular, the present invention relates to encapsulation compositions in which flavors, dry powders, dry ingredients, colors, and mixtures thereof are coated with a compressed layer of a fat or a fat mixture with a high melting point. The present fat encapsulation compositions can protect such ingredients and can form a stable delivery system and achieve the controlled release of active ingredients such as flavors, colors, etc. The present compositions also provide improved shelf life of dry powders and ingredients, specifically the hygroscopic powders and hygroscopic ingredients. The present invention also relates to a method for preparing such fat encapsulation compositions.

2. Description of the Background

Currently, in the food industry, fat encapsulation of various ingredients, flavors, colors, dry powders, etc. is carried out by melting a fat above its melting point, then blending it with the materials to be encapsulated, and finally cooling the mixture below the melting point of the fat by various processes, such as slabbing, milling, flaking, depositing, and spray chilling.

High speed mechanical mixing, fluid bed coating, or panning are the widely used techniques for coating the materials with the melted fat. Another process involves spraying a melted fat onto the materials that are to be encapsulated. The melted fat crystallizes when it is cooled below its melting point and forms a protective film around the materials thus encapsulating them.

U.S. Pat. Nos. 3,666,557 discloses starch gels which can be used as encapsulating agents.

U.S. Pat. No. 4,710,391 discloses a process in which a flavoring agent used to flavor fried food products is encapsulated so that the flavoring agent may be easily removed from oil used to fry the fried food product.

U.S. Pat. No. 4,839,184 discloses a delivery system comprising a dipeptide or amino acid sweetener or flavor or mixture thereof encapsulated in a mixture of fat and high melting point polyethylene wax.

U.S. Pat. No. 5,064,669 discloses controlled release flavoring powders prepared by heating a high melting point encapsulating material, such as a fat and/or wax, and one or more emulsifiers; mixing one or more water-containing flavor compositions with a texture conditioning agent; mixing the flavor compositions and texture conditioning agent with the molten fat or wax to obtain a homogeneous mixture in the form of an emulsion; and chilling the composition to provide discrete particles of solid encapsulated flavoring agent.

U.S. Pat. No. 5,409,719 discloses low-calorie confectionery fillings in which 5 to 50 wt. % of fat are present in a fat-continuous emulsion.

### SUMMARY OF THE INVENTION

Many of the above-mentioned conventional techniques used for fat encapsulation of core materials, such as flavor, colors, dry powders, etc. are time consuming in that they require depositing of the melted wall material, fat/lipids over and over again to achieve the desired wall thickness. Other conventional processes require additional steps such as size reduction by milling or grinding, to achieve a final product of the desired size.

Moreover, the walls of fat formed in some conventional fat encapsulation techniques are known to be non-uniform due to the process described above for achieving the desired wall thickness. Some portion of the encapsulated material is fully encapsulated, while some of it is coated with only a thin wall and some may not be encapsulated at all, i.e., it is exposed.

The conventional processes are generally expensive, due to the number of unit operations that are needed to complete the encapsulation. In addition, the number of pieces of equipment involved is high and as such the initial capital cost is high, cleaning time during operations is long (resulting in increased downtime), which again is an economic concern. Moreover, maintenance costs are high, due to the number of unit operations involved.

Thus, there remains a need for improved fat encapsulation compositions. There also remains a need for improved fat encapsulation compositions which are useful for encapsulating flavors, dry powders, dry ingredients, colors, active and inert organic and inorganic compounds, and mixtures thereof. There also remains a need for improved fat encapsulation compositions which provide improved protection of such ingredients and form a stable delivery system. There also remains a need for improved fat encapsulation compositions which provide for the controlled release of active ingredients such as flavors, colors, etc. There also remains a need for improved fat encapsulation compositions which provide improved shelf life of dry powders and ingredients, particularly hygroscopic powders and hygroscopic ingredients. There also remains a need for a method for preparing such fat encapsulation compositions. In particular, there remains a need for a process which may be carried out quickly and efficiently.

Accordingly, it is one object of the present invention to provide novel fat encapsulation compositions.

It is another object of the present invention to provide novel fat encapsulation compositions which are useful for encapsulating flavors, dry powders, dry ingredients, colors, active and inert organic and inorganic compounds, and mixtures thereof.

It is another object of the present invention to provide novel fat encapsulation compositions which provide improved protection of such ingredients and form a stable delivery system.

It is another object of the present invention to provide novel fat encapsulation compositions which provide for the controlled release of active ingredients such as flavors, colors, active ingredients with undesirable taste, etc.

It is another object of the present invention to provide novel fat encapsulation compositions which provide improved shelf life of dry powders/ingredients, particularly hygroscopic powders and hygroscopic ingredients.

It is another object of the present invention to provide a novel process for preparing such fat encapsulation compositions.

In a first main embodiment, these and other objects, which will become apparent during the following detailed description, have been achieved by the inventor's discovery that compositions, which comprise:

(A) a dry ingredient; and

(B) a high melting point fat, in which the dry ingredient is coated with a compressed layer of the high melting point fat,

are useful for achieving the foregoing objects.

In a second main embodiment, the inventor has also discovered that such compositions may be prepared by a process involving:

(1) forming a sandwich of a layer of high melting point fat, an amount of dry ingredient, and another layer of high melting fat; and

(2) subjecting the sandwich to pressure, to obtain a composition in which the dry ingredient is coated with a compressed layer of the high melting point fat.

In a third main embodiment, the inventor has further discovered that such compositions may be prepared by a process involving:

(1) a step for obtaining a composition in which a dry ingredient is coated with a compressed layer of a high melting point fat.

In a fourth main embodiment, the invention provides compositions prepared by a process, said process comprising:

(1) forming a sandwich of a layer of high melting point fat, an amount of dry ingredient, and another layer of high melting fat; and

(2) subjecting the sandwich to pressure, to obtain a composition in which the dry ingredient is coated with a compressed layer of the high melting point fat.

In a fifth main embodiment, the present invention provides compositions prepared by a process, said process comprising:

(1) a step for obtaining a composition in which a dry ingredient is coated with a compressed layer of a high melting point fat.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIGS. 1a and 1b show an embodiment of a two-punch press system which is useful for preparing the present compositions; and

FIG. 2 schematically depicts a three-stage process useful for preparing the present compositions.

### DETAILED DESCRIPTION OF THE PREFERRED EMBODIMENTS

I. Thus, in a first main embodiment, the present invention provides novel compositions, which comprise:

(A) a dry ingredient; and

(B) a high melting point fat,

in which the dry ingredient is coated with a compressed layer of the high melting point fat.

The dry ingredient may be any which is desired to protect or which may benefit by means of the present encapsulation technique. Preferably, the dry ingredient is a food flavoring, food coloring, food preservative, vitamin, dietary supplement, drug, prodrug, or medicine.

Examples of suitable food flavor dry ingredients are disclosed in D. A. De Rovira, The Dictionary of Favors, Food & Nutrition Press, Inc., Trumbull, Conn., 1999; Gary Reineccius, The Source Book of Flavors 2^{nd} Ed., Chapman & Hall, NY, 1994; and Catalog of Flavors, McCormick & Co., Inc., Hunt Valley, MD, 2000, which are incorporated herein by reference. Preferred food flavor dry ingredients include spray dried flavors such as CAPS® by McCormick & Co., Inc., spray dried garlic flavor, spray dried basil flavor, spray dried onion flavor, spray dried pepper flavor, spray dried black pepper flavor, spray dried cinnamon flavor, etc.

Examples of suitable food coloring dry ingredients are disclosed in M. SaltMarsh, Essential Guide to Food Additives, Leatherhead Publishing, Surrey, England, 2000; J. Smith, Food Additives Users Handbook, Blackie and Sons Ltd, London, 1991; G. A. Burdock, Encyclopedia of Food and Color Additives, CRC Press, NY, 1997; and Branen et al, Food Additives, Marcel Dekker, NY, 1990, which are incorporated herein by reference. Preferred food coloring dry ingredients include water soluble powders from Warner and Jenkins or DD Williams, colors such as yellow, red, blue green, and other shades of both lake and alumina.

Examples of suitable food preservative dry ingredients are disclosed in Kirk-Othmer, Encyclopedia of Chemical Technology, Fourth Ed., Wiley, New York, vol. 11, pp. 824-826, 1994, which is incorporated herein by reference. Preferred food preservative dry ingredients include benzoates, sorbates, propionates, organic acids (citric acid, malic acid, lactic acid, and tartaric acid), sulfites, parabens, sodium nitirate, sodium nitrite, natamycin, and nisin.

Examples of suitable vitamin or dietary supplement dry ingredients are disclosed in Kirk-Othmer, Encyclopedia of Chemical Technology, Fourth Ed., Wiley, New York, vol. 25, pp. 1-17, 1998, which is incorporated herein by reference. Preferred vitamin or dietary supplement dry ingredients include vitamin A, vitamin D, vitamin E, vitamin K, vitamin B₁, vitamin B₂, niacin, vitamin B₆, vitamin B₁₂, folic acid, pantothenic acid, biotin, and vitamin C.

Examples of suitable drug, prodrug, or medicine dry ingredients are disclosed in Kirk-Othmer, Encyclopedia of Chemical Technology, Fourth Ed., Wiley, New York, vol. 18, pp. 480-553, 1996, which is incorporated herein by reference.

The present compositions are especially advantageous when the dry ingredient is hygroscopic. Examples of hygroscopic dry ingredients are disclosed in M. SaltMarsh, Essential Guide to Food Additives, Leatherhead Publishing, Surrey, England, 2000; J. Smith, Food Additives Users Handbook, Blackie and Sons Ltd, London, 1991; G. A. Burdock, Encyclopedia of Food and Color Additives, CRC Press, NY, 1997; Branen et al, Food Additives, Marcel Dekker, NY, 1990; and M. Ash and I. Ash, Handbook of Food Additives, Gower Publishing, Hampshire, England, 1995, which are incorporated herein by reference. Preferred hygroscopic dry ingredients include hydrolyzed vegetable proteins, citric acid, malic acid, dried extract of lemon, dried extract of lime, etc. Particularly preferred hygroscopic dry ingredients include dried extracts of meat, such as beef and/or pork; poultry, such as dried chicken broth; and vegetables, such as tomato powder.

Of course it is to be understood that the dry ingredient in any given composition may actually be a mixture of two or more dry ingredients. The dry ingredient may also comprise a filler or inert diluent.

It is also possible that the dry ingredient may be prepared from or include a liquid ingredient, so long as the dry ingredient “as a whole” is dry. Thus, it is possible to use a composition in which a liquid ingredient is plated or otherwise absorbed onto a solid as the dry ingredient. Such liquid ingredients may be utilized by moistening one of the above-described dry ingredients or a carrier, such as gum arabic, starch, or maltodextrin, with the liquid flavor, color and/or active ingredient with an undesirable taste.

By the term “high melting point fat” it is meant a fat or mixture of fats which has a melting point above 36° C., preferably above 51° C., more preferably above 75° C. It is to be understood that the term “high melting point fat” includes hydrogenated and partially hydrogenated fats. It is preferred that the high melting point fat have a melting point no higher than 110° C.

Suitable high melting point fats are described in the Morgan Specialties catalog, a subsidiary of A. C. Humko et al, Paris, Ill., 2000; and F. D. Gunstone and F. B. Padley, Lipid Technologies and Applications, Marcel Dekker, Inc., New York, 1997, which are incorporated herein by reference. Preferred high melting point fats include hydrogenated or partially hydrogenated fats mainly from the group called triglycerides, such as hydrogenated palm oil, hydrogenated cotton seed oil, hydrogenated rape seed oil, hydrogenated soybean oil, hydrogenated sunflower oil, hydrogenated peanut oil, and mixtures thereof. Particularly preferred high melting point fats include Komel, Astral, Kaorich, Humkol 125, Stearine 07, Stearine 17, Carnuba fat, etc.

In a preferred embodiment, the fat is 100% by weight fat. However, it is possible that up to 25% by weight, preferably 0.01 to 25% by weight, more preferably up to 10% by weight, even more preferably 0.1 to 10% by weight, even more preferably up to 5% by weight, even more preferably 1 to 5% by weight, of the fat is replaced with a carrier material such as starch, gum arabic, xanthan gum, maltodextrin, etc. The fat-carrier mixture may be prepared by any conventional method such as melt-mixing.

The present compositions typically contain the dry ingredient in an amount of 0.05 to 50% by weight, preferably 5 to 40% by weight, more preferably 10 to 30% by weight, based on the total weight of the dry ingredient and the high melting point fat, and the high melting point fat in an amount of 50 to 99.95% by weight, preferably 60 to 95% by weight, more preferably 70 to 90% by weight, based on the total weight of the dry ingredient and the high melting point fat.

The compositions typically exist in a state in which the dry ingredient is coated by a compressed layer of the high melting point fat. By the term “compressed layer” it is meant that a certain amount of pressure is applied to the material, such that the individual particles are pressed into a layer forming a strong physical bond among the particles and also forming a layer or layers of the material.

Typically, the fat encapsulated compositions of the present invention will exist in a state of a fairly small particle or pellet having a size such that the pellet will pass through a sieve having a mesh size of 2.5 mm to 20 mm, preferably 5 mm to 10 mm, more preferably 6.5 to 7.5 mm. Although the shape of the fat encapsulated composition is not particularly limited, it will usually be in the form of a column, more typically a circular column, due the method of preparation method which is described below. The dry ingredient will typically be coated with a compressed layer of the high melting point fat having a thickness of 0.04 mm to 0.20 mm, preferably 0.5 mm to 0.15 mm, more preferably 0.75 mm to 0.10 mm.

The present fat encapsulated compositions may be prepared by any conventional method.

II. In a second main embodiment, the present invention provides a preferred method for preparing the present fat encapsulated compositions, which method involves:

(1) forming a sandwich of a layer of high melting point fat, an amount of dry ingredient, and another layer of high melting fat; and

(2) subjecting the sandwich to pressure, to obtain a composition in which the dry ingredient is coated with a compressed layer of the high melting point fat.

In the first step, a sandwich of layers of the high melting point fat above and below the a layer of the dry ingredient is formed. In a particularly preferred embodiment, this sandwich is formed in a die, by placing an amount of the fat, an amount of the dry ingredient, and additional fat sequentially in the die. The amount of the fat in the layers of the fat in the sandwich will correspond to the desired thickness of the fat coating in the final product.

After the sandwich has been formed, it is subjected to pressure. Suitably, the sandwich is subjected to a gauge pressure of 500 to 10,000 pounds per square inch (“psi”), preferably 1,000 to 5,000 psi, more preferably 2,500 to 3,000 psi, for a time of 0.1 seconds to 5 seconds, preferably 0.25 seconds to 2.5 seconds, more preferably 0.5 seconds to 1 second. The sandwich may be subjected to the pressure using any conventional device which is suited for applying the desired pressures, such as a Carver press, a tableting press with three layer rotary press, three-stage compaction equipment, etc. Preferably, the pressure is applied by means of a hydraulic press. In a particularly preferred embodiment, the pressure is applied to the sandwich while it is in the same die in which it was formed.

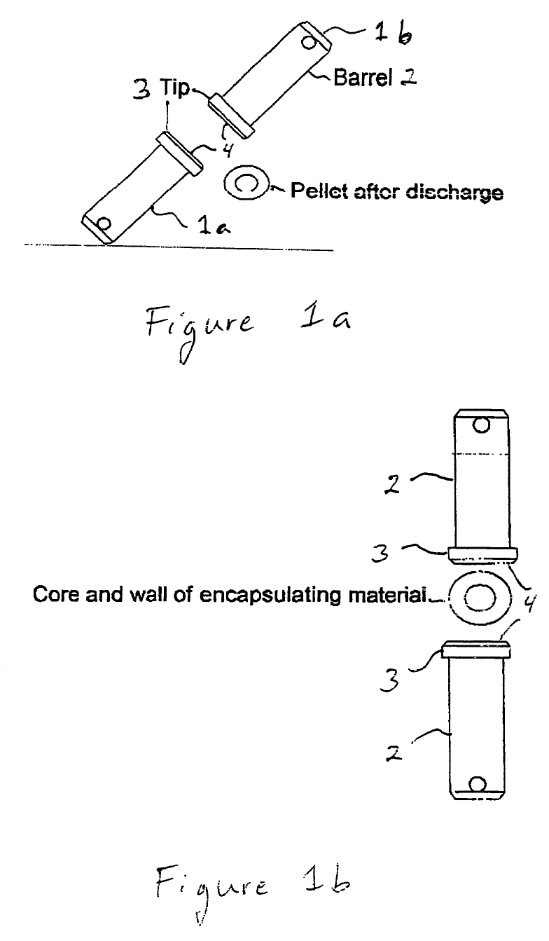

In a preferred embodiment, the present composition is prepared by using a two-punch press system as shown in FIGS. 1a and 1b. Each punch 1a and 1b is comprised of a barrel portion 2 and a tip portion 3. Each tip portion 3 has a face 4 with a recess for accepting an amount of material. Such systems are commercially available from: (1) Stokes and Merril, a Division of DT Industries, 1500 Grundy's Lane, Bristol, Pa. 19007; and (2) Elizabeth Carbide of North Carolina. By placing appropriate amounts of materials in the recess and then applying pressure, it is possible to form the present compositions.

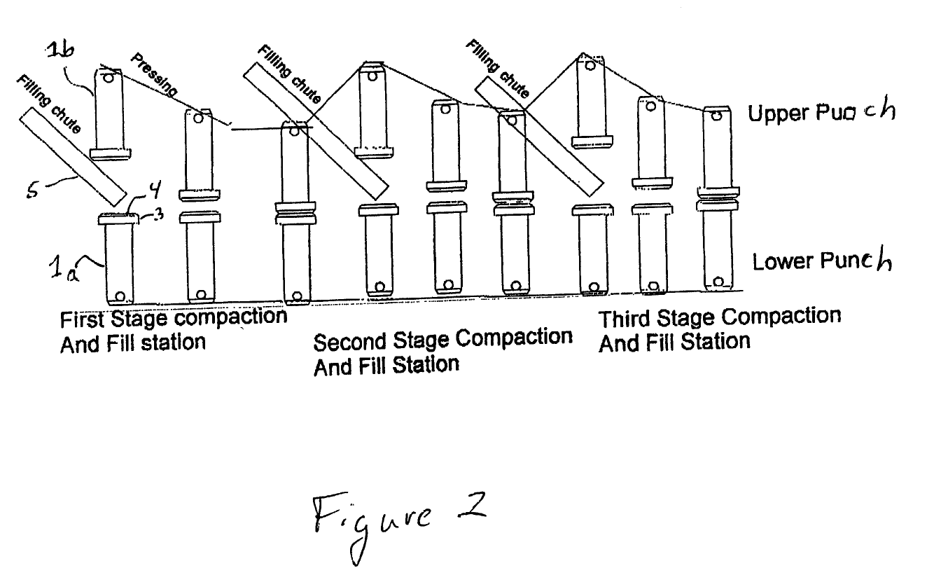

In an especially preferred embodiment, the present compositions are prepared by a three-stage process as depicted in FIG. 2. In the first stage, an amount of the high melting point fat is introduced into the recess on the face 4 of the tip portion 3 of the lower punch la via the filling chute 5. Pressure is then applied to the high melting point fat via the upper punch 1b to form a compressed layer of the high melting point fat. In the second stage, the upper punch 1b is raised, and an amount of the ingredient to be encapsulated is added on top of the compressed layer of high melting point fat via the filling chute 5. Pressure is again applied. In the third stage, the upper punch 1b is again raised, and an amount of the high melting point fat is added on top of the ingredient to be encapsulated which was added in the second stage, again via the filling chute 5. Pressure is again applied via the upper punch 1b, and upper punch 1b is raised to yield the final product.

The product may then be dusted or coated with an anti-caking agent, such as starch or silica on a conveyor belt to reduce agglomeration of the pellets.

III. In third main embodiment, the present invention provides a process for preparing a fat encapsulated composition which comprises:

(1) a step for obtaining a composition in which a dry ingredient is coated with a compressed layer of a high melting point fat.

In this third main embodiment, the step for obtaining a composition in which the dry ingredient is coated with a layer of compressed high melting point fat may be effected in the same ways that are described for steps (1) forming a sandwich of a layer of high melting point fat, an amount of dry ingredient, and another layer of high melting fat; and (2) subjecting the sandwich to pressure, to obtain a composition in which the dry ingredient is coated with a compressed layer of the high melting point fat, of the second main embodiment.

IV. In a fourth main embodiment, the present invention provides fat encapsulation compositions prepared by a process, said process comprising:

(1) forming a sandwich of a layer of high melting point fat, an amount of dry ingredient, and another layer of high melting fat; and

(2) subjecting the sandwich to pressure, to obtain a composition in which the dry ingredient is coated with a compressed layer of the high melting point fat.

In this fourth main embodiment, the ingredients and steps for preparing the composition are as described above for main embodiments I and II.

V. In a fifth main embodiment, the present invention provides fat encapsulation compositions prepared by a process, said process comprising:

(1′) a step for obtaining a composition in which a dry ingredient is coated with a compressed layer of a high melting point fat.

In this fifth main embodiment, the ingredients and steps for preparing the composition are as described above for main embodiments I and III.

The present fat encapsulation compositions and process for forming them exhibit a number of useful advantages, as compared to convention fat encapsulation compositions and methods. First, no energy is required to melt the fat for the encapsulation of materials and, as such, processing costs are reduced. In addition, the equipment used in conventional processes for melting the fat, mixing the melted fat with the dry ingredient, pumping, slabbing, milling, flaking, spraying tower, and spraying nozzle are not required. As such, the capital and operating cost are tremendously reduced.

Moreover, there is no loss of heat sensitive aromatic and/or volatile components of flavors and other ingredients during the encapsulation process, and processing yields are maximized. The fat encapsulation process is tremendously simplified, and a fully encapsulated material is achieved via a simple process. Furthermore, the highly compacted and dense fat encapsulates the active ingredients and as such forms a delivery system that is more effective in controlling release of the active ingredients.

Additionally, as described above, conventional techniques used for the fat encapsulation of materials, such as flavor, colors and dry powders etc. require the depositing of the melted wall fats/lipids over and over again to achieve the desired wall thickness. In contrast, the present method achieves the desired wall thickness in one step. The fat and the dry ingredient are weighed in a proper ratio and deposited in a chamber (die). The materials are then compressed via a plunger and the wall of the required thickness is achieved.

Further, the walls of fat formed in the conventional fat encapsulation techniques are known to be non-uniform due to the process described above for achieving the desired wall thickness. Some portion of the encapsulated material is fully encapsulated, while some of it is coated with only a thin wall and some may not be encapsulated at all, i.e., it is exposed. In contrast, the process of the present invention affords a product with a uniform wall of fat around the dry ingredient, because the geometry of the chamber (die) is well defined and is manufactured with precision measurements to obtain a uniform shape and size. Also, due to tight tolerance of the die, the material inside the chamber does not move when it is compressed with a plunger, which is also precisely designed for the chamber (die). The pressure applied during compression is also evenly distributed inside the chamber and as such the materials are compressed to form a uniform product.

The present fat encapsulation compositions also show advantageous release rates. The walls that are formed around the core material in conventional fat encapsulation techniques are known to have thicknesses on the order of micrometers, and they are non-uniform in nature and have cracks and pores. Liquids such as, water can therefore penetrate through the wall material and reach the core material, which in return is released immediately. This results in a high rate of diffusion of liquids like water into the core material and the untimely release of the core material. Also, due to penetration of the liquid through the wall material, the osmotic pressure of the encapsulated system builds up. After a short period of time osmotic rupture occurs at the weak points in the wall, once again resulting in the release of the core material.

In contrast, the present process allows for the formation of walls that are uniform, of controlled thickness and, since they are compressed, also tougher in nature. Because of this the rate of diffusion of liquids such as water into the core material is minimum to none. The diffusion will only occur if a physical or chemical change to the fat coating is used to obtain the release of the core material. This guarantees that the core material is released at the correct time and at a desired rate. The physical change which may be used to trigger the release of the dry ingredient may be heating of the encapsulated system to weaken the wall of high melting point fat, such as in cooking, or application of excessive pressure or shear, such as in chewing, whereas a chemical change could be an enzymatic reaction, which could weaken the strength of the wall material to release the core material.

Other features of the invention will become apparent in the course of the following descriptions of exemplary embodiments which are given for illustration of the invention and are not intended to be limiting thereof.

### EXAMPLES

In the following examples, and throughout this specification, all parts and percentages are by weight, and all temperatures are in degrees Celsius, unless expressly stated to be otherwise. Where the solids content of a dispersion or solution is reported, it expresses the weight of solids based on the total weight of the composition.

In Examples 1-4, the use of a conventional, spray-dried, dry flavor was compared to the use of the same flavor which had been fat encapsulated according to the present invention. The fat used for the encapsulation was either: (1) 15% by weight of Stearine 17; 15% by weight of Kaorich; and 70% by weight of Kaomel; or (2) 25% by weight of Kaorich and 75% by weight of Kaomel. Taste tests confirmed that the 25% by weight of Kaorich and 75% by weight of Kaomel mixture was preferred among the two fat systems, as the products containing Stearine had a slight waxy note. In all cases, the fat encapsulated product was prepared using a pressure of 1,500 to 3,000 psi gauge.

### Example 1

Sugar Cookies using Lemon Flavor Cap, 500 gram batch

| | |
|---|---|
| Ingredient: | Grams for Blank Product |

| | | |
|---|---|---|
| Giant Foods Margarine | 94.80 | grams |
| Domino Granulated Sugar | 174.90 | grams |
| Giant Foods Whole Egg | 46.05 | grams |
| Gold Medal All-purpose Flour | 176.35 | grams |
| Morton Iodized Salt | 2.65 | grams |
| Rumford Baking Powder | 5.25 | grams |
| Total Grams | 500.00 | grams |

The lemon flavor was either (1) 2.00 grams to 5 grams of Flavor Cap Lemon (a spray-dried lemon flavor available from McCormick & company, Inc.); or (2) 40.00 grams to 60 grams of fat-encapsulated Flavor Cap Lemon, which was prepared as described above.

The cookies were prepared as follows: Cream margarine with sugar. Add eggs. Beat until light and creamy. Sieve together flour, salt and baking powder; stir in flavoring ingredient, mixing well. Gradually add dry ingredients to creamed mixture, beating after each addition. Shape into roll. Chill minimum of 2 hours. Slice 1/8 inch thick. Bake on greased cookie sheet in preheated 375° F. oven for 8 minutes. Cool on wire racks. Unbaked dough may be stored up to 3 weeks before baking.

### Example 2

Yeast Rolls using Basil Flavor Cap, 503.43 gram batch

| | |
|---|---|
| Ingredient: | Grams for Blank Product |

| | | |
|---|---|---|
| Red Star Dry Yeast | 1.77 | grams |
| Warm Tap Water-100° F. | 29.77 | grams |
| Domino Granulated Sugar | 38.28 | grams |
| Crisco Vegetable Shortening | 38.28 | grams |
| Boiling Tap Water-212° F. | 59.53 | grams |
| Cold Tap water | 59.53 | grams |
| Fresh Whole Egg, Giant Foods | 25.00 | grams |
| Gold Medal All-purpose Flour | 249.00 | grams |
| Morton Iodized Salt | 2.27 | grams |
| Total | 503.43 | grams |

The basil flavor was either: (1) 1.5 grams to 4.0 grams of Flavor Cap Basil (a spray-dried basil flavor available from McCormick & Company, Inc.); or (2) 30.2 grams to 50.20 grams of fat-encapsulated Flavor Cap Basil which was prepared as described above.

The rolls were prepared as follows: Combine hot roll mix, yeast and flavor ingredient in large bowl of mixer. Add hot water and oil; mix 3 minutes until dough pulls away from sides of bowl. Turn dough onto lightly floured surface. With floured hands shape dough into a ball. Fold dough over a few times. Roll out to approximately 8 inches in diameter. Fold edges over until rounded. Place on cookie sheet sprayed with PAM. Prick dough with fork. Cover; let rise at warm temperature for 10 minutes. Place filling, cheese etc. on top of crust. Bake at 400° F. for 5 minutes or until golden brown and slightly bubbly.

### Example 3

Pizza Dough using Garlic Flavor Cap, 200 gram batch

The procedure for Example 2 was repeated with the following dough formula:

| | |
|---|---|
| Ingredient: | Grams for Blank Product |

| | | |
|---|---|---|
| Pillsbury Hot Roll Mix | 115.45 | grams |
| Red Star Dry Yeast | 2.80 | grams |
| Hot Tap Water-120 to 130° F. | 75.00 | grams |
| Wesson Canola Oil | 6.75 | grams |
| Total | 200.00 | grams |

The garlic flavor was either: (1) 0.80 grams of Flavor Cap Garlic (a spray-dried garlic flavor available from McCormick & Company, Inc.); or (2) 16.00 grams to 30 grams of fat-encapsulated Flavor Cap Garlic.

### Example 4

White Yeast Bread using Garlic Flavor Cap, 706.8 gram dough

| | |
|---|---|
| Ingredients: | Grams for Blank Product |

| | | |
|---|---|---|
| Fleischmann's Dry Yeast | 7.00 | grams |
| For Bread Machines | | |
| Pillsbury Bread Flour | 375.00 | grams |
| Domino Granulated Sugar | 14.20 | grams |
| Morton Iodized Table Salt | 5.60 | grams |
| NFDM solids | 14.20 | grams |
| Crisco Shortening | 11.80 | grams |
| Warm Tap Water-110° F. | 279.00 | grams |
| Total | 706.80 | grams |

The garlic flavor was either: (1) 2.93 grams to 5.0 grams of Flavor Cap Garlic (a spray-dried garlic flavor available from McCormick & Company, Inc.); or (2) 56.60 grams to 80.0 grams of fat-encapsulated Flavor Cap Garlic.

The bread was prepared as follows: Use the DAK Turbo IV Bread Machine. Pour yeast to one side of the inner pan. Add flour, sugar, salt, milk solids and shortening. If testing a flavor sample, create a well in top of dry ingredients; pour flavor sample into the well. Add water. Close machine lid; select “white bread” and do not use “turbo.” For each application, a blank was produced in addition to one product using flavor cap and another using fat encapsulated product.

In all of Examples 1-4, the products made with fat encapsulated flavors were found to be higher in flavor retention and as such had a stronger impact during consumption. Also, the products prepared with the fat-encapsulated flavors were judged to be having more of green note such as in Garlic and Basil flavors and in case of lemon flavor the flavor was referred to as fresh lemon as compared to the candy like lemon for the non-fat-encapsulated product. Overall, fat encapsulation preserved the freshness and intensity of the flavors, whereas the non-encapsulated flavors lost their intensity and also developed a different version of the flavor like candy like lemon.

### Example 5

To further exemplify the present compositions and method, the following experiments were carried out.

Raw Materials Tested: All materials were water soluble and/or hygroscopic in nature. Blue Dye FD&C #1, Red Dye FD&C #40, Flavor Cell Strawberry flavor and strawberry color, HVP 4BE, HVP 3H3, AYE Autolyzed Yeast and NaCl table salt.

Encapsulating Media: Stearine 17, Kaorich and 75% & 25% blend of these fats.

Equipment Used: Hydraulic press, Laboratory Carver Press, Various size dies for compaction and for obtaining different shapes and sizes.

Methods and Results:

A. Procedure: Add 50% of the total fat to the die and compress to 1,000 psia. Add ingredients to be encapsulated and then add rest of the fat to the die. Compress to 2,500 psia. Remove tablet from the die.

Results: Some initial release of color in water bath and then no release after ½ hour. Product stayed intact for 48 hours. For hygroscopic materials slight moisture pick up initially on the perimeter but after that no moisture pick up for 48 hrs.

B. Method: Add 50% of the total fax to die and compress to 1,000 psia. Add material to be encapsulated and compress to 1,000 psia. Add rest of the fat and compress to 2,500 psia. Remove tablet from the die. Place fat encapsulated color tablet in H₂O and leave others on bench top.

Results: Product behaved very similar to the products obtained above. It was due to the same non encapsulated material on the edges. No release or moisture pick up was observed after 72 hours. All products were discarded after 72 hours.

C. Method: Compress ingredient and/or ingredients to be encapsulated in the die at a pressure of 1,000 psia and remove it from the die. Add 50% of the fat and compress to 1,000 psia. Reintroduce the compressed material from step 1 to the die. Add rest of the fat and compress to 2,500 psia. Remove tablet from the die and repeat as above.

Results: No release of color observed. No moisture pick up by the hygroscopic materials was found. This indicated that the ingredients were 100% encapsulated by this procedure. On commercial basis a process like this can be duplicated with a three station or dual station tablet in tablet press.

D. Method: Add fat to the die and compress to 1,000 psia. Add ingredients to be encapsulated and compress to 2,500 psia. Remove the two layer tablet. This procedure was only used with hygroscopic ingredients.

Results: Product stayed in tact for 48 hours and then fell apart.

E. Method: Add fat and the ingredients to be encapsulated to the die and compress it to 2,500 psia. Remove the tablet.

Results: Product stayed intact for 72 hours and then the products were discarded.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

What is claimed as new and desired to be secured by Letters patent of the United States is:

1. A composition, comprising
(A) a dry ingredient; and
(B) a high melting point fat,
in which said dry ingredient is coated with a compressed layer of said high melting point fat.

2. The composition of claim 1, wherein said dry ingredient is selected from the group consisting of food flavorings food colorings food preservatives vitamins dietary supplements drugs prodrugs, and medicines.

3. The composition of claim 1, wherein said high melting point fat has a melting point of 36° C. to 110° C.

4. The composition of claim 1, wherein said high melting point fat is a triglyceride.

5. The composition of claim 1, wherein said high melting point fat is selected from the group consisting of hydrogenated palm oil, hydrogenated cotton seed oil, hydrogenated rape seed oil, hydrogenated soybean oil, hydrogenated sunflower oil, hydrogenated peanut oil, and mixtures thereof.

6. The composition of claim 1, wherein said fat comprises up to 25% by weight of an ingredient selected from the group consisting of starch, gum arabic, xanthan gum, and maltodextrin.

7. The composition of claim 1, wherein said compressed layer of high melting point fat has a thickness of from 0.04 mm to 0.20 mm.

8. The composition of claim 1, wherein said composition exists in the state of a particle having a size such that it will pass through a sieve having a mesh size of 0.35 mm to 20 mm.

9. A process for preparing a composition, comprising:
(1) forming a sandwich of a layer of high melting point fat, an amount of dry ingredient, and another layer of high melting fat; and
(2) subjecting the sandwich to pressure, to obtain a composition in which the dry ingredient is coated with a compressed layer of the high melting point fat.

10. The process of claim 9, wherein said dry ingredient is selected from the group consisting of food flavorings food colorings food preservatives vitamins dietary supplements drugs prodrugs, and medicines.

11. The process of claim 9, wherein said high melting point fat has a melting point of 36° C. to 110° C.

12. The process of claim 9, wherein said high melting point fat is a triglyceride.

13. The process of claim 9, wherein said high melting point fat is selected from the group consisting of hydrogenated palm oil, hydrogenated cotton seed oil, hydrogenated rape seed oil, hydrogenated soybean oil, hydrogenated sunflower oil, hydrogenated peanut oil, and mixtures thereof.

14. The process of claim 9, wherein said fat comprises up to 25% by weight of an ingredient selected from the group consisting of starch, gum arabic, xanthan gum, and maltodextrin.

15. The process of claim 9, wherein said compressed layer of high melting point fat has a thickness of from 0.04 mm to 0.20 mm.

16. The process of claim 9, wherein said composition exists in the state of a particle having a size such that it will pass through a sieve having a mesh size of 0.35 mm to 20 mm.

17. The process of claim 9, wherein said sandwich is subjected to a gauge pressure of 500 pounds/square inch to 10,000 pounds/square inch for a time of 0.1 seconds to 5 seconds.

18. A process for preparing a composition, comprising:
(1) a step for obtaining a composition in which a dry ingredient is coated with a compressed layer of a high melting point fat.

19. The process of claim 18, wherein said step for obtaining a composition in which a dry ingredient is coated with a compressed layer of a high melting point fat comprises:
(1′) a step for forming a sandwich of a layer of high melting point fat, an amount of dry ingredient, and another layer of high melting fat; and
(2′) a step for subjecting the sandwich to pressure, to obtain a composition in which the dry ingredient is coated with a compressed layer of the high melting point fat.

20. The process of claim 18, wherein said dry ingredient is selected from the group consisting of food flavorings food colorings food preservatives vitamins dietary supplements drugs prodrugs, and medicines.

21. The process of claim 18, wherein said high melting point fat has a melting point of 36° C. to 110° C.

22. The process of claim 18, wherein said high melting point fat is a triglyceride.

23. The process of claim 18, wherein said high melting point fat is selected from the group consisting of hydrogenated palm oil, hydrogenated cotton seed oil, hydrogenated rape seed oil, hydrogenated soybean oil, hydrogenated sunflower oil, hydrogenated peanut oil, and mixtures thereof.

24. The process of claim 19, wherein said fat comprises up to 25% by weight of an ingredient selected from the group consisting of starch, gum arabic, xanthan gum, and maltodextrin.

25. The process of claim 18, wherein said compressed layer of high melting point fat has a thickness of from 0.04 mm to 0.20 mm.

26. The process of claim 18, wherein said composition exists in the state of a particle having a size such that it will pass through a sieve having a mesh size of 0.35 mm to 20 mm.

27. The process of claim 18, wherein said sandwich is subjected to a gauge pressure of 500 pounds/square inch to 10,000 pounds/square inch for a time of 0.1 seconds to 5 seconds.

28. A composition prepared by a process, said process comprising:
(1) forming a sandwich of a layer of high melting point fat, an amount of dry ingredient, and another layer of high melting fat; and
(2) subjecting the sandwich to pressure, to obtain a composition in which the dry ingredient is coated with a compressed layer of the high melting point fat.

29. The composition of claim 28, wherein said dry ingredient is selected from the group consisting of food flavorings food colorings food preservatives vitamins dietary supplements drugs prodrugs, and medicines.

30. The composition of claim 28, wherein said high melting point fat has a melting point of 36° C. to 110° C.

31. The composition of claim 28, wherein said high melting point fat is a triglyceride.

32. The composition of claim 28, wherein said high melting point fat is selected from the group consisting of hydrogenated palm oil, hydrogenated cotton seed oil, hydrogenated rape seed oil, hydrogenated soybean oil, hydrogenated sunflower oil, hydrogenated peanut oil, and mixtures thereof.

33. The composition of claim 28, wherein said fat comprises up to 25% by weight of an ingredient selected from the group consisting of starch, gum arabic, xanthan gum, and maltodextrin.

34. The composition of claim 28, wherein said compressed layer of high melting point fat has a thickness of from 0.04 mm to 0.20 mm.

35. The composition of claim 28, wherein said composition exists in the state of a particle having a size such that it will pass through a sieve having a mesh size of 0.35 mm to 20 mm.

36. The composition of claim 28, wherein said sandwich is subjected to a pressure of 0.25 tons/square inch to 5.0 tons/square inch for a time of 0.1 seconds to 5 seconds.

37. A composition prepared by a process, said process comprising:
(1) a step for obtaining a composition in which a dry ingredient is coated with a compressed layer of a high melting point fat.

38. The composition of claim 37, wherein said step for obtaining a composition in which a dry ingredient is coated with a compressed layer of a high melting point fat comprises:
(1′) a step for forming a sandwich of a layer of high melting point fat, an amount of dry ingredient, and another layer of high melting fat; and
(2′) a step for subjecting the sandwich to pressure, to obtain a composition in which the dry ingredient is coated with a compressed layer of the high melting point fat.

39. The composition of claim 37, wherein said dry ingredient is selected from the group consisting of food flavorings food colorings food preservatives vitamins dietary supplements drugs prodrugs, and medicines.

40. The composition of claim 37, wherein said high melting point fat has a melting point of 36° C. to 110° C.

41. The composition of claim 37, wherein said high melting point fat is a triglyceride.

42. The composition of claim 37, wherein said high melting point fat is selected from the group consisting of hydrogenated palm oil, hydrogenated cotton seed oil, hydrogenated rape seed oil, hydrogenated soybean oil, hydrogenated sunflower oil, hydrogenated peanut oil, and mixtures thereof.

43. The composition of claim 37, wherein said fat comprises up to 25% by weight of an ingredient selected from the group consisting of starch, gum arabic, xanthan gum, and maltodextrin.

44. The composition of claim 37, wherein said compressed layer of high melting point fat has a thickness of from 0.04 mm to 0.20 mm.

45. The composition of claim 37, wherein said composition exists in the state of a particle having a size such that it will pass through a sieve having a mesh size of 0.35 mm to 20 mm.

46. The composition of claim 37, wherein said sandwich is subjected to a gauge pressure of 500 pounds/square inch to 10,000 pounds/square inch for a time of 0.1 seconds to 5 seconds.
